(19) United States
(12) Patent Application Publication
(10) Pub. No.: US 2026/0239027 A1
(43) Pub. Date: Aug. 13, 2026

(54) MODEL SELECTION BASED ON TRAINING FEATURE VECTORS

(71) Applicant: QUALCOMM Incorporated, San Diego, CA (US)

(72) Inventors: Hua Wang, Basking Ridge, NJ (US); Wooseok Nam, San Diego, CA (US); Tao Luo, San Diego, CA (US)

(21) Appl. No.: 19/052,062

(22) Filed: Feb. 12, 2025

(51) Int. Cl. H04W 24/02; G06N 3/08; H04B 7/06

(52) U.S. Cl. CPC H04W 24/02; G06N 3/08; H04B 7/0626; H04B 7/06952

(57) ABSTRACT

Certain aspects of the present disclosure provide techniques for model selection based on training feature vectors. In some aspects, a wireless communication device may obtain, at a comparison neural network (NN), a plurality of training feature vectors associated with a plurality of training datasets associated with a plurality of NN models. The wireless communication device may obtain, at the comparison NN, an input feature vector associated with an input dataset. The wireless communication device may determine, using the comparison NN, a plurality of similarity scores based at least in part on the input feature vector and the plurality of training feature vectors. Each similarity score may indicate a similarity between the input feature vector and a respective training feature vector. The wireless communication device may select an NN model of the plurality of NN models based at least in part on the plurality of similarity scores.

### FIELD OF THE INVENTION

Aspects of the present disclosure relate to wireless communications, and more particularly, to techniques for model selection based on training feature vectors.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a wireless communication device. The method includes obtaining, at a comparison NN, a plurality of training feature vectors associated with a plurality of NN models, wherein each training dataset of a plurality of training datasets is associated with a respective NN model of the plurality of NN models, and wherein each training feature vector of the plurality of training feature vectors corresponds to a respective training dataset of the plurality of training datasets; obtaining, at the comparison NN, an input feature vector associated with an input dataset; determining, using the comparison NN, a plurality of similarity scores based at least in part on the input feature vector and the plurality of training feature vectors, wherein each similarity score of the plurality of similarity scores indicates a similarity between the input feature vector and a respective training feature vector of the plurality of training feature vectors; and selecting an NN model of the plurality of NN models based at least in part on the plurality of similarity scores.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example artificial intelligence (AI) architecture that may be used for AI-enhanced wireless communications.

FIG. 6 depicts an example AI architecture of a first wireless device that is in communication with a second wireless device.

FIG. 7 depicts an example artificial neural network.

FIG. 8 depicts a process for operations of a wireless communication device.

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for model selection based on training feature vectors.

Artificial intelligence (AI) and machine learning (ML) techniques (herein collectively referred to as AI/ML) can be used to enhance performance of a wireless communication system. For example, an AI/ML model can be configured to predict or manage beamforming associated with a wireless communication device, which is helpful for maintaining high data rates and reliable connections, especially in high-mobility scenarios. As another example, an AI/ML model can be configured to facilitate reducing overhead and improving accuracy of channel state information (CSI) feedback, which is important for efficient resource allocation and maintaining high-quality connections. As another example, an AI/ML model can be configured to enhance positioning accuracy of a wireless communication device (e.g., in an environment with non-line-of-sight (NLOS) conditions), which improves performance in an application that requires accurate or precise location information.

In practice, channels in a wireless communication system exhibit different and varying properties (e.g., depending on location), which can significantly impact performance of the wireless communication system. The difference and variability of wireless channels may therefore necessitate the use of different AI/ML models that are trained on data distributions (e.g., data distributions specific to respective locations) to achieve optimal performance. In general, the different AI/ML models may have the same model architecture, but parameters of the AI/ML models may be different (e.g., due to the difference in training data used to train a given AI/ML model). In some scenarios, the type of AI/ML model that is suitable for a given application may be readily apparent based on circumstances of the application, such as location (e.g., urban area versus rural area, indoor environment versus outdoor environment, or the like) or mobility (e.g., high-mobility versus low-mobility).

However, in some scenarios, it is not readily apparent which AI/ML model of a group of AI/ML models is best-suited for a set of circumstances (e.g., a particular location, a particular mobility scenario, or the like). For example, a first AI/ML model may be trained using training datasets related to a first urban environment (e.g., San Francisco) and a second AI/ML model may be trained using training datasets related to second urban environment (e.g., San Diego). In such a scenario, which of the first AI/ML model or the second AI/ML model is best-suited for use in a third urban environment (e.g., Los Angeles) is not readily apparent.

One technique that can be used for model selection is to compare outputs (e.g., predictions) of different candidate models with an actual measurement (e.g., an over-the-air (OTA) measurement) and then determine which of the different candidate models provided the better result. One drawback to this technique is that the best-suited model cannot be determined prior to obtaining sufficient actual measurement results, which increases latency with respect to model selection (and subsequent use) and, therefore, degrades network performance. Furthermore, obtaining the actual measurement results uses processing and battery resources of a wireless communication device performing the selection. Another drawback of this technique is that, as a number of candidate models increases, the technique is not scalable. For example, as the number of models for which outputs need to generated increases, latency and resource usage increases. With an increasing number of candidate models, this latency and resource usage may be not practical. Thus, technical problems for AI/ML model selection may include, for example, latency with respect to use of the model and resource consumption of a wireless communication device.

Aspects described herein may overcome the aforementioned technical problems, for example, by providing AI/ML model selection based on training features associated with AI/ML models. In some aspects, a wireless communication device may be configured with a comparison neural network (NN). The wireless communication device may obtain training feature vectors associated with a plurality of models (e.g., candidate AI/ML models for a given application), and an input feature vector associated with an input dataset (e.g., actual measurement data). In some aspects, a feature vector (e.g., a training feature vector or an input feature vector) is a numerical representation (e.g., a series of numerical values) of a dataset (e.g., a training dataset or an input dataset). In some aspects, the feature vector may have a structured format (e.g., such that the training feature vector can be understood and processed by the comparison NN). In some aspects, a feature vector may comprise or be referred to as an embedding. The wireless communication device may then determine a plurality of similarity scores using the comparison NN. Here, each similarity score indicates a similarity between the input feature vector and a respective training feature vector of the plurality of training feature vectors associated with the plurality of models. The wireless communication device may then select a model based at least in part on the plurality of similarity scores (e.g., the wireless communication device may select the model with the highest similarity score). Notably, according to the techniques and apparatuses herein the wireless communication device selects a best-suited model for a given application based on training data associated with a plurality of candidate models (e.g., rather than based on outputs of each of the candidate models).

Certain techniques for model selection based on training feature vectors described herein may provide various beneficial technical effects and/or advantages. The techniques for model selection based on training feature vectors may enable improved wireless communications performance, such as reduced latency with respect to model selection and use, reduced power consumption, reduced processing resource consumption, or the like. These improvements with respect to wireless communication performance may be attributable to the techniques and apparatuses described herein, for example, due to the use of training feature vectors in association with performing model selection (e.g., rather than model outputs). Additional details are provided below.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

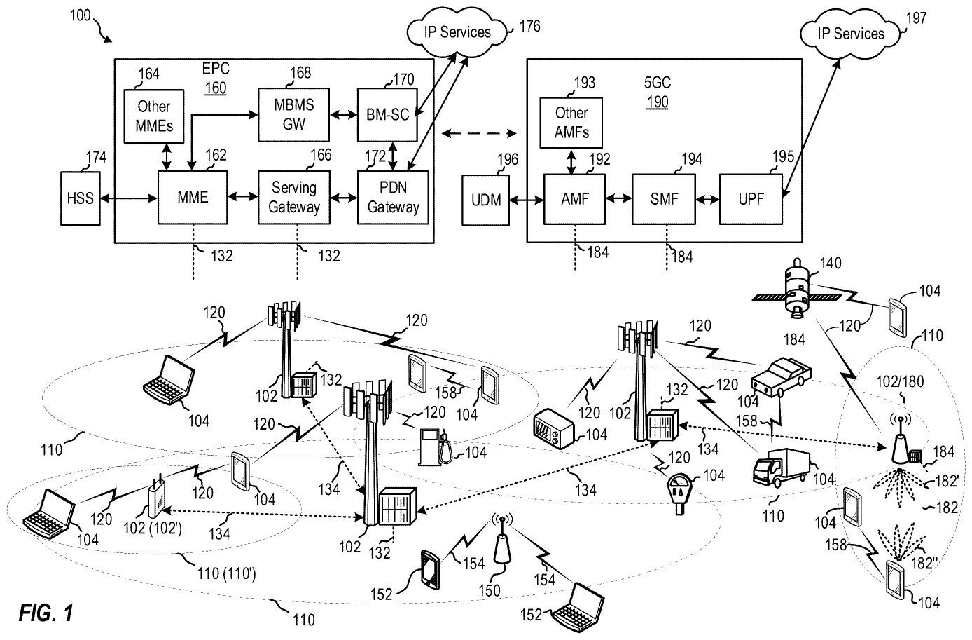

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

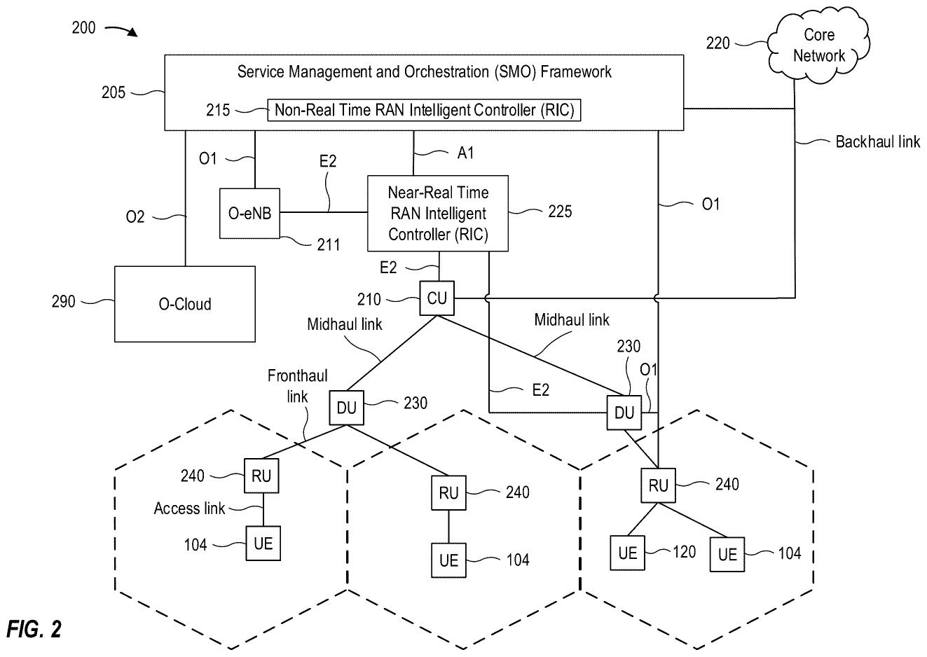

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

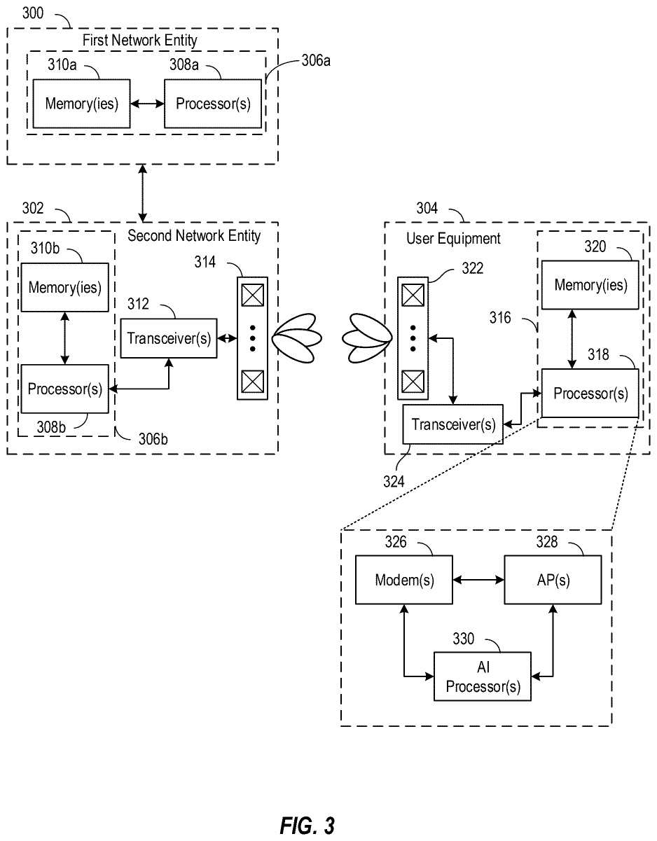

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

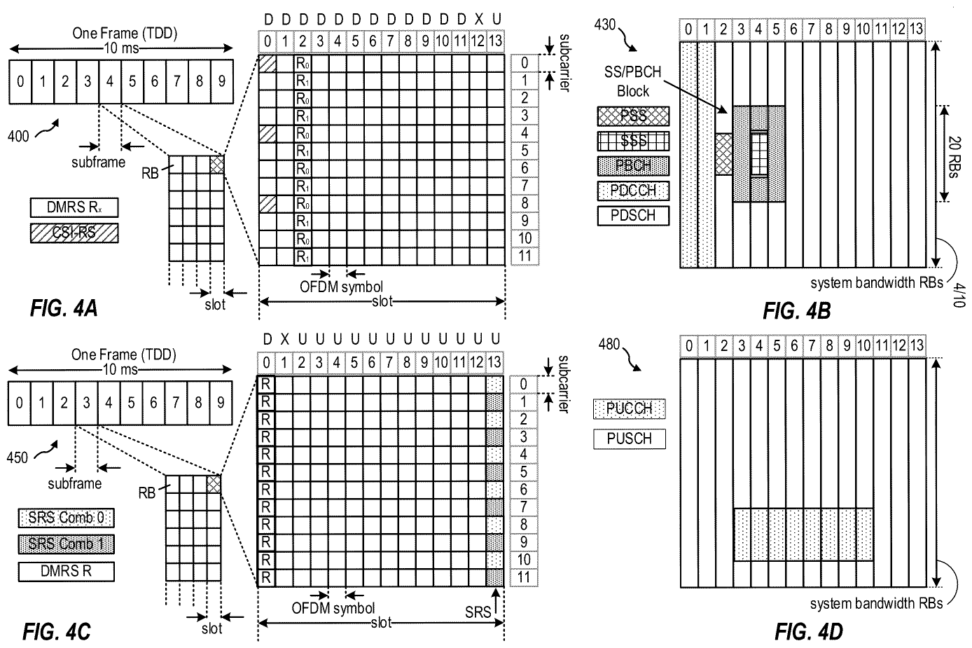

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

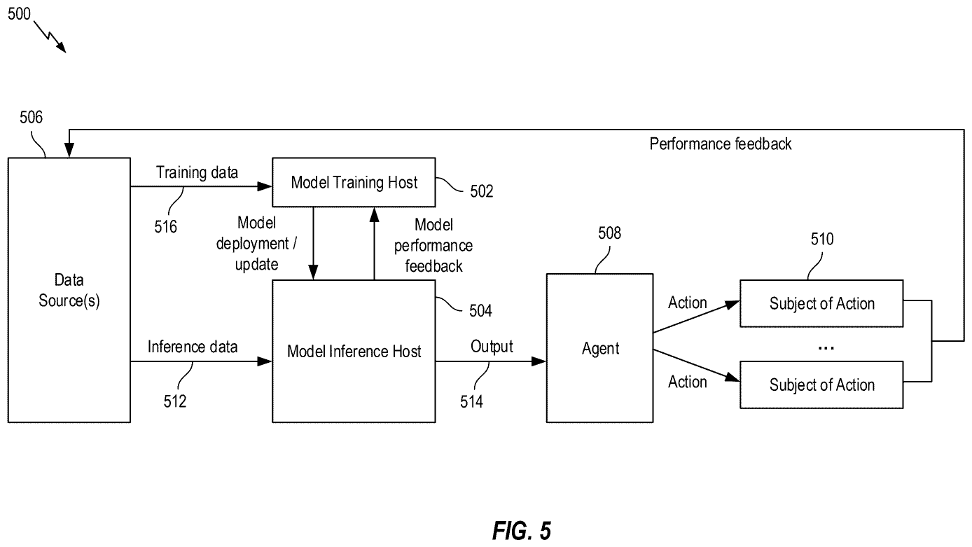

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, etc. In certain examples, the agent 508 may be an example of a decision agent. In some examples, the agent 508 may be a UE, a base station, or any disaggregated network entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a UE, a CU, a DU, or an RU and the output from model inference host 504 is a plurality of similarity scores associated with selecting a model from a plurality of NN models, then the agent 508 may select the NN model based on the output 514. In some aspects, if the agent 508 determines to act based on the output 514, agent 508 may indicate the action to at least one subject of the action 510. For example, if the agent 508 selects a NN model to be used by the subject of action 510 (e.g., a UE, a CU, DU, or an RU), the agent 508 may send an indication to the subject of action 510 to cause the subject of action 510 to use the selected model.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, an ML model is deployed at or on a wireless communication device (e.g., a UE or a network entity) for model selection based on training feature vectors. More specifically, a model inference host, such as model inference host 504 in FIG. 5, may be deployed at or on the UE or the network entity for model selection based on training feature vectors.

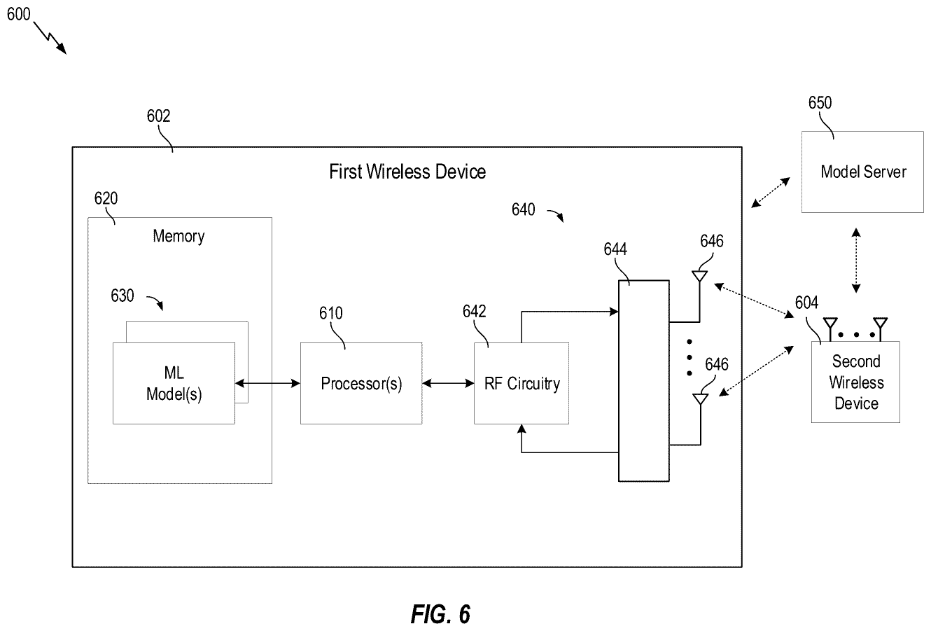

FIG. 6 illustrates an example AI architecture 600 of a first wireless device 602 that is in communication with a second wireless device 604. The first wireless device 602 may be a UE or a network entity (e.g., a BS) as described herein with respect to FIGS. 1-3. Similarly, the second wireless device 604 may be a network entity or a UE as described herein with respect to FIGS. 1-3. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take training feature vectors and an input feature vector as input to generate a plurality of similarity scores associated with a plurality of NN models. The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), a block error rate (BLER), channel state information (CSI), image information, or the like. The output data may include, for example, one or more similarity scores, each indicating a similarity between the input feature vector and a respective training feature vector of the plurality of training feature vectors.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

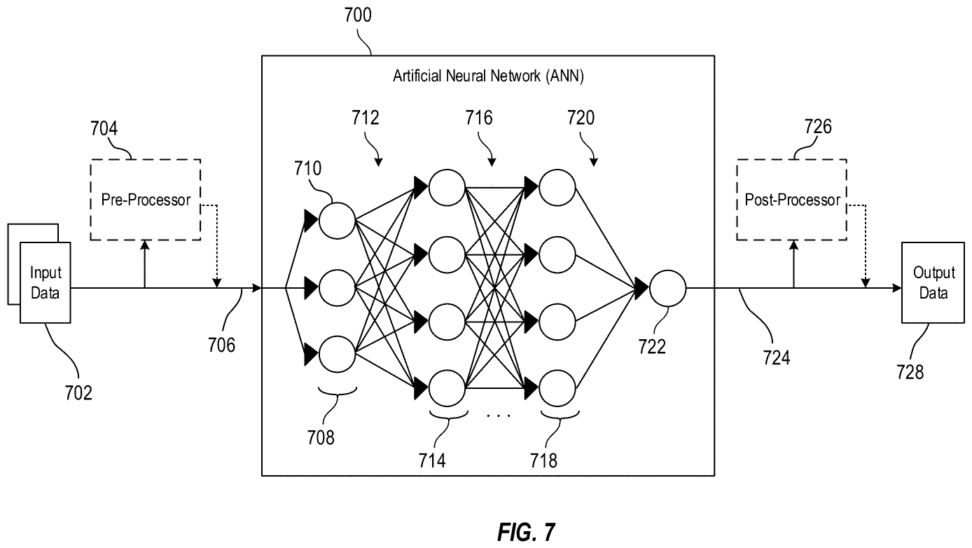

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more UEs, one or more network entities, or one or more other devices in a wireless communication system. In some cases, all or part of the training data may be aggregated from multiple sources (e.g., one or more UEs, one or more network entities, the Internet, etc.). For example, wireless network features such as self-organizing networks (SONs) or minimization of drive test (MDT) features, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A dropout technique may be used to randomly drop out some of the artificial neurons from a model during a training process, e.g., in order to reduce overfitting and potentially improve the generalization of the model.

An early stopping technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a pruning technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a CU, a DU, an RU, or the like.

### Example Signaling of Model Selection Based on Training Feature Vectors

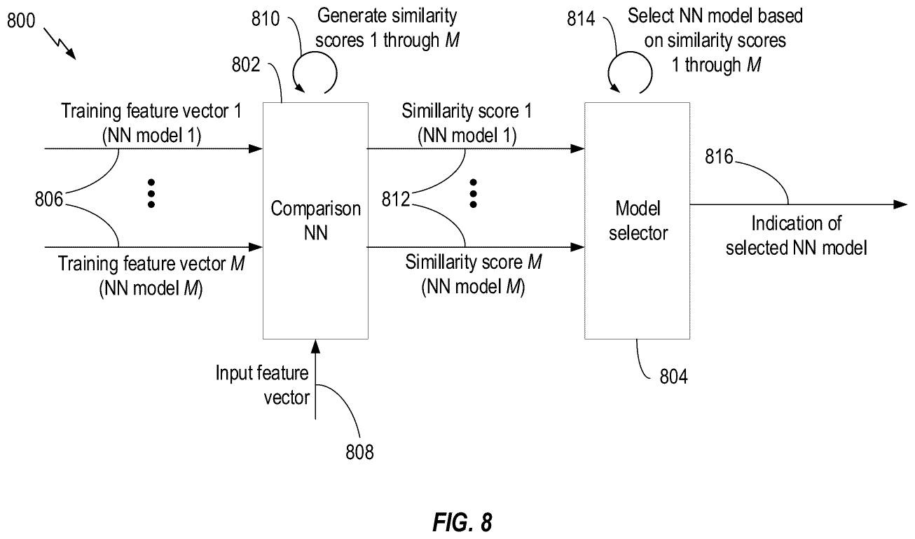

FIG. 8 depicts an example for operations of a wireless communication device 800. In some aspects, the wireless communication device 800 may be an example of the BS 102 depicted and described with respect to FIG. 1, the first network entity 300 or the second network entity 302 depicted and described with respect to FIG. 3, a disaggregated base station depicted and described with respect to FIG. 2, or the first wireless device 602 or the second wireless device 604 depicted and described with respect to FIG. 6. In some aspects, the wireless communication device 800 may be an example of UE 104 depicted and described with respect to FIG. 1, the UE 304 depicted and described with respect to FIG. 3, or the first wireless device 602 or the second wireless device depicted and described with respect to FIG. 6. However, in other aspects, the wireless communication device 800 may be another type of wireless communications device, such as those described herein.

As further shown in FIG. 8, the wireless communication device 800 may comprise a comparison NN 802 and a model selector 804. In some aspects, the comparison NN 802 may be implemented at model inference host 504 depicted and described with respect to FIG. 5 and/or may include ANN 700 depicted and described with respect to FIG. 7. In some aspects, the model selector 804 may be an example of agent 508 or model inference host 504 depicted and described with respect to FIG. 5.

At 806, the wireless communication device 800 obtains, at the comparison NN 802, a plurality of training feature vectors (e.g., training feature vectors 1 through M (M>1)) associated with a plurality of NN models (e.g., NN models 1 through M). The plurality of NN models comprises a plurality of NN models from which the wireless communication device 800 is to select an NN model for use in a given application. In one example, the plurality of NN models may include NN models associated with performing beam management with respect to communications of the wireless communication device 800. In another example, the plurality of NN models may include NN models associated with performing CSI feedback enhancement with respect to communications of the wireless communication device 800. In another example, the plurality of NN models may include NN models associated with providing positioning accuracy with respect to operations of the wireless communication device 800. In some aspects, a given NN model in the plurality of NN models may be an example of an ML model 630 depicted and described with respect to FIG. 6. Notably, while the plurality of NN models are depicted and described with respect to FIG. 8 as being NN models, the plurality of NN models may in some aspects include another type of AI/ML model (e.g., a model type other than an NN).

In some aspects, each the plurality of NN models is trained based on different training datasets (e.g., each NN model in the plurality of NN models may be trained on a different respective set of training data). In general, an NN model is trained using a training dataset having a particular distribution. In practice, although such an NN model may have some generalization capability to be used outside of the distribution of the training dataset, the NN model typically achieves improved performance when the NN model is used to generate an output based on an input dataset having a distribution similar to that of the training dataset. For example, a first NN model may be trained using a first training dataset and a second NN model may be trained using a second training dataset, with a distribution of the first training dataset being different from a distribution of the second training dataset. Here, if a distribution of an input dataset is similar to the distribution of the first training dataset (and is dissimilar to the distribution of the second training dataset), then the first NN model is likely to provide a better (e.g., more accurate or reliable) output than the second NN model. In one particular example, a Radio UNet model can be used to predict an RSRP map using image information of a surrounding environment. Here, if the Radio UNet model is trained or tuned based on image information associated with a first location, it may be practical to use the Radio UNet model to generate an RSRP map prediction using image information associated with a second location, if the image information associated with the first location is similar to the image information associated with the second location (e.g., if an environment of the first location is similar to an environment of the second location). Conversely, if the distribution of the input dataset is similar to the distribution of the second training dataset (and is dissimilar to the distribution of the first training dataset), then the second NN model is likely to provide a better output than the first NN model. Thus, selection of the most-suitable NN model based at least in part on training feature vectors, as described herein, may serve to ensure that the most-suitable NN model in a given scenario is selected, thereby improving accuracy and reliability with respect to use of an output of an NN model.

In some aspects, a training feature vector is a feature vector corresponding to a training dataset associated with an NN model. That is, a training feature vector may be a feature vector that is generated based on a dataset with which the NN model is trained or a portion of the dataset with which the NN model is trained. In some aspects, the training feature vector may be a numerical representation (e.g., a series of numerical values) of the training dataset, or the portion of the training dataset. The numerical representation of the training dataset, or the portion of the training dataset, may have a structured format (e.g., such that the training feature vector can be understood and processed by the comparison NN 802).

In some aspects, each training feature vector of the plurality of training feature vectors corresponds to a respective training dataset of a plurality of training datasets, with each training dataset of the plurality of training datasets being associated with a respective NN model of the plurality of NN models. Thus, each training feature vector may be associated with a respective NN model in the plurality of NN models.

In some aspects, the wireless communication device 800 may generate one or more of the plurality of training feature vectors. For example, in some aspects, the wireless communication device 800 may obtain (e.g., receive from another wireless communication device) one or more training datasets associated with one or more of the plurality of NN models. The wireless communication device 800 may then generate the one or more training feature vectors based at least in part on the one or more training datasets obtained by the wireless communication device 800. Additionally or alternatively, the wireless communication device 800 may receive one or more training feature vectors of the plurality of training feature vectors. For example, the wireless communication device 800 may receive (e.g., from another wireless communication device) a transmission that includes the one or more training feature vectors (e.g., when the one or more training feature vectors are generated by the other wireless communication device). In some such aspects, the wireless communication device 800 may transmit a request for the one or more training feature vectors, and may receive the one or more training feature vectors in response to the request.

At 808, the wireless communication device 800 obtains, at the comparison NN 802, an input feature vector associated with an input dataset. The input dataset is a dataset based at least in part on an output (e.g., a prediction, a recommendation, a value, or the like) that is to be provided by an NN model. For example, the input dataset may include position information associated with one or more wireless communication devices. As another example, the input dataset may include CSI (e.g., measurements) associated with the wireless communication device 800. As another example, the input dataset may include image information (e.g., one or more images of an environment around the wireless communication device 800).

In some aspects, the input feature vector is a feature vector corresponding to the input dataset. That is, the input feature vector may be a feature vector that is generated based on (e.g., includes one or more features of) a dataset based at least in part on which an output of an NN model is to be generated in a given application. In some aspects, the input feature vector may be a numerical representation (e.g., a series of numerical values) of the input dataset, or a portion of the input dataset. The numerical representation of the input dataset, or the portion of the input dataset, may have a structured format (e.g., such that the input feature vector can be understood and processed by the comparison NN 802).

In some aspects, the wireless communication device 800 may generate the input feature vector. For example, in some aspects, the wireless communication device 800 may obtain the input dataset. As particular examples, the wireless communication device 800 may receive the input dataset from another wireless communication device, or may obtain the input dataset based on performing one or more measurements. The wireless communication device 800 may then generate the input feature vector based at least in part on the input dataset obtained by the wireless communication device 800. Additionally or alternatively, the wireless communication device 800 may receive the input feature vector. For example, the wireless communication device 800 may receive (e.g., from another wireless communication device) a transmission that includes the input feature vector (e.g., when the input feature vector is generated by the other wireless communication device). In some such aspects, the wireless communication device 800 may transmit a request for the input feature vector, and may receive the input feature vector in response to the request.

In some aspects, a feature vector as described herein (e.g., a training feature vector or a input feature vector) may comprise an embedding. As used herein, an embedding is a type of feature vector that represents a complex dataset (e.g., text, an image, or the like) as a lower-dimensional vector that captures relationships and patterns within the dataset (e.g., to enable efficient processing and similarity comparisons). In some aspects, an embedding can be learned automatically by the comparison NN 802, which allows the comparison NN 802 to discover complex patterns in a dataset. In some aspects, the embedding may be used to project high-dimensional data into a lower-dimensional space.

At 810, the wireless communication device 800 determines, using the comparison NN 802, a plurality of similarity scores (e.g., similarity scores 1 through M) based at least in part on the input feature vector and the plurality of training feature vectors. In some aspects, a similarity score includes a value (e.g., a numerical value) that indicates a similarity between the input feature vector and a training feature vector of the plurality of training feature vectors. Thus, each similarity score of the plurality of similarity scores may indicate a similarity between the input feature vector and a respective training feature vector of the plurality of training feature vectors.

In some aspects, the plurality of similarity scores may be determined based at least in part on a plurality of feature space distances. As used herein, a feature space distance is a distance between an input feature vector and a training feature vector within a feature space. As used herein, a feature space is a multi-dimensional space that represents possible values of feature vectors. In some aspects, each dimension of the multi-dimensional feature space corresponds to a respective data point in the feature vector. In some aspects, the feature space allows feature vectors to be visualized or analyzed as data points within the feature space.

In some aspects, in association with determining the plurality of similarity scores based at least in part on the feature space distances, the comparison NN 802 may map the plurality of training feature vectors and the input feature vector in one or more feature spaces. For example, to determine a similarity score for a given NN model, the comparison NN 802 may map the input feature vector and a training feature vector, associated with the given NN model, as data points within a feature space. The comparison NN 802 may then compute a feature space distance based at least in part on a result of the mapping. That is, the comparison NN 802 may compute a distance between the data point associated with the input feature vector and the data point associated with the training feature vector in the feature space. The comparison NN 802 may then determine the similarity score based at least in part on the features space distance. For example, the similarity score may be determined as a value equal to the feature space distance. As another example, the similarity score may be determined as a value equal to a normalized version of the feature space distance. The comparison NN 802 may determine each similarity score in the plurality of similarity scores in a similar manner. In one example, each similarity score may be a value in a particular range (e.g., a value normalized to fall within in a range from 0.0 to 1.0).

In some aspects, the comparison NN 802 may be trained according to a contrastive learning technique. Contrastive learning is a technique that facilitates learning representations by comparing similar and dissimilar data points. Contrastive learning may be particularly useful in, for example, scenarios where labeled data is scarce, which makes contrastive learning a suitable choice for self-supervised learning. In general, contrastive learning enables mapping of similar samples (e.g., data points) closer together in a representation space (e.g., a feature space) while keeping dissimilar samples comparatively further apart in the representation space. In some aspects, according to the contrastive learning technique, the comparison NN 802 may learn to minimize distances between similar samples while maximizing distances between dissimilar samples by minimizing a contrastive loss. In some aspects, after training according to the contrastive learning technique, the learned representations can be used for tasks such as classification, clustering, and retrieval.

At 812, the wireless communication device 800 provides the plurality of similarity scores to the model selector 804.

At 814, the wireless communication device 800 selects, using the model selector 804, an NN model of the plurality of NN models based at least in part on the plurality of similarity scores. In some aspects, the wireless communication device 800 may select the NN model as the NN model with the highest similarity score (e.g., such that the NN model with the training feature vector that is most similar to the input feature vector is selected as the NN model to be used to generate an output based on the input dataset). Additionally or alternatively, the wireless communication device 800 may select the NN model based at least in part on a similarity threshold. For example, the wireless communication device 800 may identify one or more similarity scores that satisfy (e.g., are greater than or equal to) a similarity threshold, and may select the NN model from the one or more NN models corresponding to the one or more similarity scores that satisfy a threshold. In such a scenario, if multiple similarity scores satisfy the threshold, the wireless communication device 800 may select from among the associated multiple NN models (e.g., randomly, in a predetermined order, or the like). In an example in which no similarity scores satisfy the similarity threshold, the wireless communication device 800 may refrain from selecting an NN model. Alternatively, the wireless communication device 800 may select the NN model that is closest to the similarity threshold. In such a scenario, the wireless communication device 800 may provide (e.g., to a wireless communication device that is to use an output of the selected NN model) an indication that the similarity score did not satisfy the similarity threshold (e.g., to indicate that the output of the selected NN model may have a low accuracy or reliability).

In some aspects, the wireless communication device 800 may communicate parameter information associated with the selected NN model. The parameter information may include one or more parameter values associated with configuring the selected NN model for use in generating an output based at least in part on the input dataset. For example, in some aspects, the wireless communication device 800 may transmit a request for parameter information associated with the selected NN model, and may receive a response to the request, with the response including the parameter information. Such a scenario may occur when, for example, the wireless communication device 800 is a UE and, after selection of the NN model, the wireless communication device 800 is to obtain the parameter information associated with the selected NN model from a network entity based on a request.

Additionally or alternatively, the wireless communication device 800 may receive a request for parameter information associated with the selected NN model, and transmit a response to the request, with the response including the parameter information. Such a scenario may occur when, for example, the wireless communication device 800 is a network entity and after selection of the NN model, is to provide the parameter information associated with the selected NN model to a UE based on a request.

At 816, the wireless communication device 800 provides, using the model selector 804, an indication of the selected NN model. For example, the wireless communication device 800, using the model selector 804, may provide an indication to (e.g., another component of the wireless communication device 800) cause the wireless communication device 800 to use the selected NN model to generate an output based on the input dataset. In some aspects, the wireless communication device 800 may use the parameter information (e.g., obtained as described above) in association with configuring the NN model. In some aspects, the wireless communication device 800 may provide the input dataset as an input to the selected NN model, and may receive an output dataset as an output of the selected NN model. That is, the wireless communication device 800 may use the NN model selected by the comparison NN 802 to generate an output dataset based on the input dataset.

In some aspects, the wireless communication device 800 may perform proactive model switching with respect to NN model selection. For example, an environment of the wireless communication device 800 may change (e.g., due to UE mobility) such that the previously selected NN model does not provide sufficiently accurate or reliable output in a new environment of the wireless communication device 800. A conventional technique to address such a scenario is to compare an output of the selected NN model with an actual result (e.g., an actual measurement result) in order to determine whether the selected NN model provides a sufficiently accurate or reliable output (e.g., whether the output of the selected NN model output causes an error or is significantly different than the actual result). Here, if the output of the NN model is no longer accurate or reliable, then a wireless communication device could select another NN model or fallback to a conventional (e.g., non-ML) technique in a given application. However, this reactive type of NN model switching increases a model switching time and increases a likelihood that a wireless communication device uses an NN model that provides insufficiently accurate or reliable outputs.

Thus, in some aspects, the wireless communication device 800 may perform proactive model selection. In some aspects, to perform proactive model selection, the wireless communication device 800 may obtaining, at the comparison NN 802, a second input feature vector associated with a second input dataset (e.g., a second set of input data, obtained after the set of input data based at least in part on which the NN model was selected). The wireless communication device 800 may then determine, using the comparison NN 802, whether a difference between the second input feature vector and a training feature vector associated with the selected NN model satisfies (e.g., a greater than or equal to) a difference threshold. Here, if the difference between the second input feature vector and the training feature vector associated with the selected NN model satisfies the difference threshold, then the wireless communication device 800 may determine, using the comparison NN 802, a second plurality of similarity scores based at least in part on the second input feature vector and the plurality of training feature vectors. Here, each similarity score of the second plurality of similarity scores indicates a similarity between the second input feature vector and a respective training feature vector of the plurality of training feature vectors. The wireless communication device 800 may then select a second NN model of the plurality of NN models based at least in part on the second plurality of similarity scores (e.g., in a manner similar to that described above). In this way, the wireless communication device 800 may proactively perform model switching (e.g., based at least in part on the second input feature vector and the plurality of training feature vectors), which reduces model switching time and, furthermore, reduces a likelihood that the wireless communication device 800 relies on an inaccurate or unreliable model output provided by the previously selected NN model.

In some aspects, as noted above, the wireless communication device 800 may be a network entity that is to select an NN model from a plurality of NN models. In some such aspects, the network entity may use the comparison NN 802 to generate the plurality of training feature vectors from the plurality of training datasets or to generate the input feature vector from the input dataset. The network entity may then compare the training feature vectors and the input feature vector (e.g., based on mapping to a feature space and generating the plurality of similarity scores) and select a suitable NN model, accordingly. In some such aspects, the input dataset may be collected by a UE and provided to the network entity. Alternatively, the input dataset may be collected by the network entity. In aspects in which the input dataset is collected by a UE, the UE can in some aspects provide the input dataset to the network entity. Alternatively, the UE can generate the input feature vector and provide the input feature vector to the network entity. In some aspects, providing the input feature vector (rather than the input dataset itself) reduces overhead associated with NN model selection.

In some aspects, as noted above, the wireless communication device 800 may be a UE. In some such aspects, the plurality of NN models may be hosted on a network entity or other network device. In some such aspects, the UE may generate or collect the input dataset. In some aspects, a network entity may generate the plurality of training feature vectors associated with the plurality of NN models. Here, rather than providing parameter information associated with each model, the network entity may provide the UE with the training feature vectors. In this way, overhead associated with NN model selection is reduced. The UE may generate the input feature vector based on the input dataset. The UE may then compare the training feature vectors and the input feature vector (e.g., based on mapping to a feature space and generating the plurality of similarity scores) and select a suitable NN model, accordingly. In such an aspect, the UE can then request, from the network entity, the parameter information for the selected NN models. Such an approach reduces overhead by requiring only the training feature vectors associated with the plurality of NN models and the parameter information associated with the selected NN model to be communicated to the UE (e.g., rather than requiring parameter information for each NN model in the plurality of NN models to be communicated to the UE).

In some aspects, information associated with performing model selection based on training feature vectors in the manner described herein may be communicated between the wireless communication device 800 and one or more other wireless communication devices. Such information may include, for example, input datasets (e.g., measured input data such as position data, CSI, image information, or the like), training datasets, input feature vectors, training feature vectors, or parameter information associated with one or more NN models (e.g., parameter information associated with the comparison NN 802, parameter information associated with one or more NN models from a plurality of NN models, or the like), among other examples. In some aspects, one or more items of such information may be communicated via, for example, a Long Term Evolution positioning protocol (LPP)-like messaging protocol or an NR positioning protocol A (NRPPA)-like messaging protocol. Additionally or alternatively, one or more items of such information may be communicated via, for example, system information, radio resource control (RRC) signaling, a medium access control (MAC) control element (CE), uplink control information (UCI), downlink control information (DCI), or an inter-UE coordination message (IUC), among other examples. Additionally or alternatively, one or more items of such information may be communicated through one or more different links, such as a broadcast link, a unicast link, a Uu link, a sidelink, or an F1/Xn link, among other examples. Further, in some aspects one or more items of such information may be stored such that the information is distributed among multiple network entities (e.g., one or more gNBs, servers, location management functions (LMFs), access and mobility management functions (AMFs), or the like).

Note that the process flow illustrated in FIG. 8 is an example of model selection based on training feature vectors, and aspects of the present disclosure may be applied to model selection based on training feature vectors. Note that the example illustrated in FIG. 8 is described herein to facilitate an understanding of model selection based on training feature vectors, and aspects of the present disclosure may be performed in various manners via alternative or additional signaling and/or operations. In certain aspects, the operations of FIG. 8 may occur in an order different from that described or depicted, and various actions, operations, and/or signaling may be added, omitted, or combined.

### Example Operations of a Wireless Communication Device

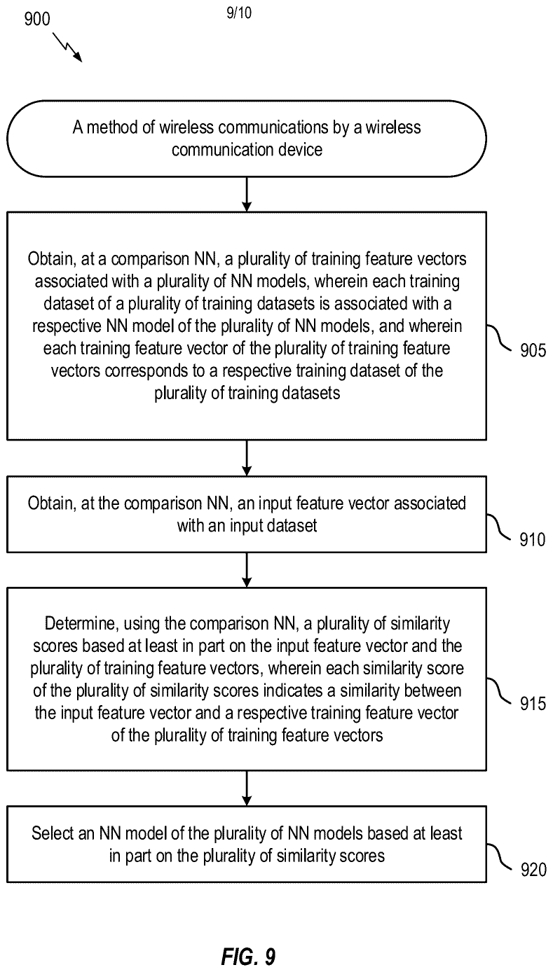

FIG. 9 shows a method 900 of wireless communications by a wireless communication device, such as UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 900 begins at block 905 with obtaining, at a comparison NN, a plurality of training feature vectors associated with a plurality of NN models, wherein each training dataset of a plurality of training datasets is associated with a respective NN model of the plurality of NN models, and wherein each training feature vector of the plurality of training feature vectors corresponds to a respective training dataset of the plurality of training datasets. For example, a wireless communication device 800 may obtain, at a comparison NN 802, a plurality of training feature vectors as depicted and described with respect to reference 806 of FIG. 8.

Method 900 then proceeds to block 910 with obtaining, at the comparison NN, an input feature vector associated with an input dataset. For example, the wireless communication device 800 may obtain, at a comparison NN 802, an input feature vector associated with an input dataset as depicted and described with respect to reference 808 of FIG. 8.

Method 900 then proceeds to block 915 with determining, using the comparison NN, a plurality of similarity scores based at least in part on the input feature vector and the plurality of training feature vectors, wherein each similarity score of the plurality of similarity scores indicates a similarity between the input feature vector and a respective training feature vector of the plurality of training feature vectors. For example, the wireless communication device 800 may determine, using the comparison NN 802, a plurality of similarity scores based at least in part on the input feature vector and the plurality of training feature vectors, as depicted and described with respect to reference 810 of FIG. 8.

Method 900 then proceeds to block 920 with selecting an NN model of the plurality of NN models based at least in part on the plurality of similarity scores. For example, the wireless communication device 800 may select an NN model of the plurality of NN models based at least in part on the plurality of similarity scores, as depicted and described with respect to reference 814 of FIG. 8.

In some aspects, the method 900 for model selection based on training feature vectors provides various beneficial technical effects and/or advantages. For example, the method 900 may enable improved wireless communications performance, such as reduced latency with respect to model selection and use, reduced power consumption, reduced processing resource consumption, or the like. These improvements with respect to wireless communication performance may be attributable to the operations associated with method 900, for example, due to the use of training feature vectors in association with performing model selection (e.g., rather than model outputs).

In some aspect, method 900 further includes mapping the plurality of training feature vectors and the input feature vector in a feature space.

In some aspect, method 900 further includes computing a plurality of feature space distances based at least in part on a result of the mapping, wherein each feature space distance of the plurality of feature space distances indicates a distance between the input feature vector and a respective training feature vector of the plurality of training feature vectors in the feature space, wherein block 915 includes determining the plurality of similarity scores based at least in part on the plurality of feature space distances.

In some aspect, method 900 further includes training the comparison NN according to a contrastive learning technique.

In some aspects, block 910 includes: receiving a transmission that includes the input dataset; and generating the input feature vector based at least in part on the input dataset.

In some aspects, block 910 includes receiving a transmission that includes the input feature vector.

In some aspects, block 905 includes: obtaining the plurality of training datasets; and generating the plurality of training feature vectors based at least in part on the plurality of training datasets.

In some aspects, block 905 includes receiving a transmission that includes the plurality of training feature vectors.

In some aspect, method 900 further includes transmitting a request for parameter information associated with the selected NN model.

In some aspect, method 900 further includes receiving a response to the request, wherein the response includes the parameter information.

In some aspect, method 900 further includes receiving a request for parameter information associated with the selected NN model, and transmitting a response to the request, wherein the response includes the parameter information.

In some aspect, method 900 further includes providing the input dataset as an input to the selected NN model, and receiving an output dataset as an output of the selected NN model.

In some aspects, the plurality of NN models includes a plurality of NN models associated with performing beam management.

In some aspects, the plurality of NN models includes a plurality of NN models associated with performing channel state information feedback enhancement.

In some aspects, the plurality of NN models includes a plurality of NN models associated with providing positioning accuracy.

In some aspect, method 900 further includes obtaining, at the comparison NN, a second input feature vector associated with a second input dataset.

In some aspect, method 900 further includes determining, using the comparison NN, that a difference between the second input feature vector and a training feature vector, of the plurality of training feature vectors, that is associated with the selected NN model satisfies a threshold.

In some aspect, method 900 further includes determining, using the comparison NN, a second plurality of similarity scores based at least in part on the second input feature vector and the plurality of training feature vectors, wherein each similarity score of the second plurality of similarity scores indicates a similarity between the second input feature vector and a respective training feature vector of the plurality of training feature vectors.

In some aspect, method 900 further includes selecting a second NN model of the plurality of NN models based at least in part on the second plurality of similarity scores.

In some aspects, the input dataset includes at least of: position information associated with one or more wireless communication devices, channel state information, or image information.

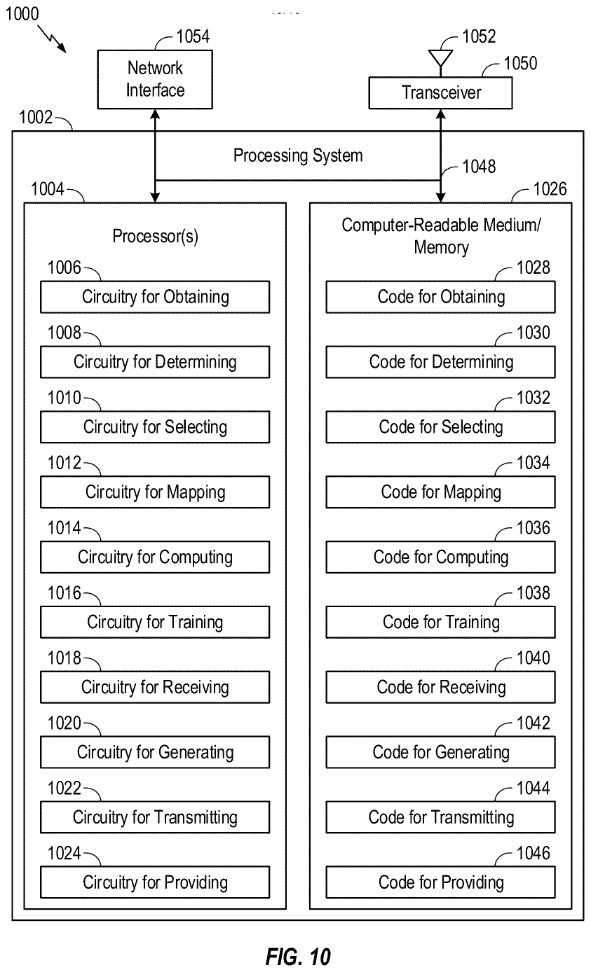

In some aspect, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative operations are possible consistent with this disclosure.

### Example Communication Device

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3. In some aspects, communications device 1000 is a network entity, such as BS 102 of FIG. 1, first network entity 300 or second network entity of FIG. 3, or a disaggregated base station as discussed with respect to FIG. 2.

The communications device 1000 includes a processing system 1002 coupled to a transceiver 1050 (e.g., a transmitter and/or a receiver) and/or a network interface 1054. The transceiver 1050 is configured to transmit and receive signals for the communications device 1000 via an antenna 1052, such as the various signals as described herein. The network interface 1054 is configured to obtain and send signals for the communications device 1000 via communications link(s), such as a backhaul link, midhaul link, and/or fronthaul link as described herein, such as with respect to FIG. 2. The processing system 1002 may be configured to perform processing functions for the communications device 1000, including processing signals received and/or to be transmitted by the communications device 1000.

The processing system 1002 includes one or more processors 1004 and a computer-readable medium/memory 1026. In various aspects, the one or more processors 1004 may be representative of the one or more processors 318 described with respect to FIG. 3. The one or more processors 1004 are coupled to a computer-readable medium/memory 1026 via a bus 1048. In some aspects, the computer-readable medium/memory 1026 may be representative of the one or more memories 320 described with respect to FIG. 3. The computer-readable medium/memory 1026 is a non-transitory computer-readable medium/memory. In certain aspects, the computer-readable medium/memory 1026 is configured to store instructions (e.g., computer-executable code), that when executed by the one or more processors 1004, cause the one or more processors 1004 to perform the method 900 described with respect to FIG. 9, or any aspect related to it, including any operations described in relation to FIG. 9. Note that reference to a processor performing a function of communications device 1000 may include one or more processors performing that function of communications device 1000, such as in a distributed fashion.

In the depicted example, computer-readable medium/memory 1026 stores code (e.g., executable instructions), including code for obtaining 1028, code for determining 1030, code for selecting 1032, code for mapping 1034, code for computing 1036, code for training 1038, code for receiving 1040, code for generating 1042, code for transmitting 1044, and code for providing 1046. Processing of the code 1028-1046 may enable and cause the communications device 1000 to perform the method 900 described with respect to FIG. 9, or any aspect related to it. For example, in some aspects, code for obtaining 1028 includes code for obtaining, at a comparison NN, a plurality of training feature vectors associated with a plurality of NN models, wherein each training dataset of a plurality of training datasets is associated with a respective NN model of the plurality of NN models, and wherein each training feature vector of the plurality of training feature vectors corresponds to a respective training dataset of the plurality of training datasets. In some aspects, code for obtaining 1028 includes code for obtaining, at the comparison NN, an input feature vector associated with an input dataset. In some aspects, code for determining 1030 includes code for determining, using the comparison NN, a plurality of similarity scores based at least in part on the input feature vector and the plurality of training feature vectors, wherein each similarity score of the plurality of similarity scores indicates a similarity between the input feature vector and a respective training feature vector of the plurality of training feature vectors. In some aspects, code for selecting 103 includes code for selecting an NN model of the plurality of NN models based at least in part on the plurality of similarity scores.

The one or more processors 1004 include circuitry configured to implement (e.g., execute) the code stored in the computer-readable medium/memory 1026, including circuitry for obtaining 1006, circuitry for determining 1008, circuitry for selecting 1010, circuitry for mapping 1012, circuitry for computing 1014, circuitry for training 1016, circuitry for receiving 1018, circuitry for generating 1020, circuitry for transmitting 1022, and circuitry for providing 1024. Processing with circuitry 1006-1024 may enable and cause the communications device 1000 to perform the method 900 described with respect to FIG. 9, or any aspect related to it. For example, in some aspects, circuitry for obtaining 1006 includes circuitry for obtaining, at a comparison NN, a plurality of training feature vectors associated with a plurality of NN models, wherein each training dataset of a plurality of training datasets is associated with a respective NN model of the plurality of NN models, and wherein each training feature vector of the plurality of training feature vectors corresponds to a respective training dataset of the plurality of training datasets. In some aspects, circuitry for obtaining 1006 includes circuitry for obtaining, at the comparison NN, an input feature vector associated with an input dataset. In some aspects circuitry for determining 1008 includes circuitry for determining, using the comparison NN, a plurality of similarity scores based at least in part on the input feature vector and the plurality of training feature vectors, wherein each similarity score of the plurality of similarity scores indicates a similarity between the input feature vector and a respective training feature vector of the plurality of training feature vectors. In some aspects, circuitry for selecting 1010 includes circuitry for selecting an NN model of the plurality of NN models based at least in part on the plurality of similarity scores.

More generally, means for communicating, transmitting, sending or outputting for transmission may include the one or more transceivers 324, one or more antennas 322, and/or processing system 316 of the UE 304 illustrated in FIG. 3, transceiver 1050, and/or antenna 1052, of the communications device 1000 in FIG. 10; and/or one or more processors 1004 of the communications device 1000 in FIG. 10. Means for communicating, receiving or obtaining may include the one or more transceivers 324, one or more antennas 322, and/or processing system 316 of the UE 304 illustrated in FIG. 3, transceiver 1050, and/or antenna 1052, of the communications device 1000 in FIG. 10; and/or one or more processors 1004 of the communications device 1000 in FIG. 10.

### Example Clauses

Implementation examples are described in the following numbered clauses:
Clause 1: A method of wireless communications by a wireless communication device, comprising: obtaining, at a comparison NN, a plurality of training feature vectors associated with a plurality of NN models, wherein each training dataset of a plurality of training datasets is associated with a respective NN model of the plurality of NN models, and wherein each training feature vector of the plurality of training feature vectors corresponds to a respective training dataset of the plurality of training datasets; obtaining, at the comparison NN, an input feature vector associated with an input dataset; determining, using the comparison NN, a plurality of similarity scores based at least in part on the input feature vector and the plurality of training feature vectors, wherein each similarity score of the plurality of similarity scores indicates a similarity between the input feature vector and a respective training feature vector of the plurality of training feature vectors; and selecting an NN model of the plurality of NN models based at least in part on the plurality of similarity scores.
Clause 2: The method of Clause 1, further comprising: mapping the plurality of training feature vectors and the input feature vector in a feature space; and computing a plurality of feature space distances based at least in part on a result of the mapping, wherein each feature space distance of the plurality of feature space distances indicates a distance between the input feature vector and a respective training feature vector of the plurality of training feature vectors in the feature space, wherein determining the plurality of similarity scores comprises determining the plurality of similarity scores based at least in part on the plurality of feature space distances.
Clause 3: The method of any one of Clauses 1-2, further comprising training the comparison NN according to a contrastive learning technique.
Clause 4: The method of any one of Clauses 1-3, wherein obtaining the input feature vector comprises: receiving a transmission that includes the input dataset; and generating the input feature vector based at least in part on the input dataset.
Clause 5: The method of any one of Clauses 1-4, wherein obtaining the input feature vector comprises receiving a transmission that includes the input feature vector.
Clause 6: The method of any one of Clauses 1-5, wherein obtaining the plurality of training feature vectors comprises: obtaining the plurality of training datasets; and generating the plurality of training feature vectors based at least in part on the plurality of training datasets.
Clause 7: The method of any one of Clauses 1-6, wherein obtaining the plurality of training feature vectors comprises receiving a transmission that includes the plurality of training feature vectors.
Clause 8: The method of any one of Clauses 1-7, further comprising: transmitting a request for parameter information associated with the selected NN model; and receiving a response to the request, wherein the response includes the parameter information.
Clause 9: The method of any one of Clauses 1-8, further comprising: receiving a request for parameter information associated with the selected NN model, and transmitting a response to the request, wherein the response includes the parameter information.
Clause 10: The method of any one of Clauses 1-9, further comprising: providing the input dataset as an input to the selected NN model, and receiving an output dataset as an output of the selected NN model.
Clause 11: The method of any one of Clauses 1-10, wherein the plurality of NN models includes a plurality of NN models associated with performing beam management.
Clause 12: The method of any one of Clauses 1-11, wherein the plurality of NN models includes a plurality of NN models associated with performing channel state information feedback enhancement.
Clause 13: The method of any one of Clauses 1-12, wherein the plurality of NN models includes a plurality of NN models associated with providing positioning accuracy.
Clause 14: The method of any one of Clauses 1-13, further comprising: obtaining, at the comparison NN, a second input feature vector associated with a second input dataset; determining, using the comparison NN, that a difference between the second input feature vector and a training feature vector, of the plurality of training feature vectors, that is associated with the selected NN model satisfies a threshold; determining, using the comparison NN, a second plurality of similarity scores based at least in part on the second input feature vector and the plurality of training feature vectors, wherein each similarity score of the second plurality of similarity scores indicates a similarity between the second input feature vector and a respective training feature vector of the plurality of training feature vectors; and selecting a second NN model of the plurality of NN models based at least in part on the second plurality of similarity scores.
Clause 15: The method of any one of Clauses 1-14, wherein the input dataset includes at least of: position information associated with one or more wireless communication devices, channel state information, or image information.
Clause 16: One or more apparatuses, comprising: one or more memories comprising executable instructions; and one or more processors configured to execute the executable instructions and cause the one or more apparatuses to perform a method in accordance with any one of Clauses 1-15.
Clause 17: One or more apparatuses configured for wireless communications, comprising: one or more memories; and one or more processors, coupled to the one or more memories, configured to cause the one or more apparatuses to perform a method in accordance with any one of Clauses 1-15.
Clause 18: One or more apparatuses configured for wireless communications, comprising: one or more memories; and one or more processors, coupled to the one or more memories, configured to perform a method in accordance with any one of Clauses 1-15.
Clause 19: One or more apparatuses, comprising means for performing a method in accordance with any one of Clauses 1-15.
Clause 20: One or more non-transitory computer-readable media comprising executable instructions that, when executed by one or more processors of one or more apparatuses, cause the one or more apparatuses to perform a method in accordance with any one of Clauses 1-15.
Clause 21: One or more computer program products embodied on one or more computer-readable storage media comprising code for performing a method in accordance with any one of Clauses 1-15
Clause 22: One or more apparatuses configured for wireless communications, comprising: a processing system that includes one or more processors and one or more memories coupled with the one or more processors, the processing system configured to cause the one or more apparatuses to perform a method in accordance with any one of Clauses 1-15.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause a wireless communication device to:
obtain, at a comparison NN, a plurality of training feature vectors associated with a plurality of NN models,
wherein each training dataset of a plurality of training datasets is associated with a respective NN model of the plurality of NN models, and
wherein each training feature vector of the plurality of training feature vectors corresponds to a respective training dataset of the plurality of training datasets;
obtain, at the comparison NN, an input feature vector associated with an input dataset;
determine, using the comparison NN, a plurality of similarity scores based at least in part on the input feature vector and the plurality of training feature vectors,
wherein each similarity score of the plurality of similarity scores indicates a similarity between the input feature vector and a respective training feature vector of the plurality of training feature vectors; and
select an NN model of the plurality of NN models based at least in part on the plurality of similarity scores.

2. The apparatus of claim 1, wherein the processing system is configured to further cause the wireless communication device to:
map the plurality of training feature vectors and the input feature vector in a feature space; and
compute a plurality of feature space distances based at least in part on a result of the mapping, wherein each feature space distance of the plurality of feature space distances indicates a distance between the input feature vector and a respective training feature vector of the plurality of training feature vectors in the feature space,
wherein determining the plurality of similarity scores comprises determining the plurality of similarity scores based at least in part on the plurality of feature space distances.

3. The apparatus of claim 1, wherein the processing system is configured to further cause the wireless communication device to:
train the comparison NN according to a contrastive learning technique.

4. The apparatus of claim 1, wherein to cause the wireless communication device to obtain the input feature vector, the processing system is configured to cause the wireless communication device to:
receive a transmission that includes the input dataset; and
generate the input feature vector based at least in part on the input dataset.

5. The apparatus of claim 1, wherein obtaining the input feature vector comprises receiving a transmission that includes the input feature vector.

6. The apparatus of claim 1, wherein to cause the wireless communication device to obtain the plurality of training feature vectors, the processing system is configured to cause the wireless communication device to:
obtain the plurality of training datasets; and
generate the plurality of training feature vectors based at least in part on the plurality of training datasets.

7. The apparatus of claim 1, wherein to cause the wireless communication device to obtain the plurality of training feature vectors, the processing system is configured to cause the wireless communication device to receive a transmission that includes the plurality of training feature vectors.

8. The apparatus of claim 1, wherein the processing system is configured to further cause the wireless communication device to:
transmit a request for parameter information associated with the selected NN model; and
receive a response to the request, wherein the response includes the parameter information.

9. The apparatus of claim 1, wherein the processing system is configured to further cause the wireless communication device to:
receive a request for parameter information associated with the selected NN model; and
transmit a response to the request, wherein the response includes the parameter information.

10. The apparatus of claim 1, wherein the processing system is configured to further cause the wireless communication device to:
provide the input dataset as an input to the selected NN model, and receiving an output dataset as an output of the selected NN model.

11. The apparatus of claim 1, wherein the plurality of NN models includes a plurality of NN models associated with performing beam management.

12. The apparatus of claim 1, wherein the plurality of NN models includes a plurality of NN models associated with performing channel state information feedback enhancement.

13. The apparatus of claim 1, wherein the plurality of NN models includes a plurality of NN models associated with providing positioning accuracy.

14. The apparatus of claim 1, wherein the processing system is configured to further cause the wireless communication device to:
obtain, at the comparison NN, a second input feature vector associated with a second input dataset;
determine, using the comparison NN, that a difference between the second input feature vector and a training feature vector, of the plurality of training feature vectors, that is associated with the selected NN model satisfies a threshold;
determine, using the comparison NN, a second plurality of similarity scores based at least in part on the second input feature vector and the plurality of training feature vectors,
wherein each similarity score of the second plurality of similarity scores indicates a similarity between the second input feature vector and a respective training feature vector of the plurality of training feature vectors; and
select a second NN model of the plurality of NN models based at least in part on the second plurality of similarity scores.

15. The apparatus of claim 1, wherein the input dataset includes at least of:
position information associated with one or more wireless communication devices,
channel state information, or
image information.

16. A method of wireless communications by a wireless communication device, comprising:
obtaining, at a comparison NN, a plurality of training feature vectors associated with a plurality of NN models,
wherein each training dataset of a plurality of training datasets is associated with a respective NN model of the plurality of NN models, and
wherein each training feature vector of the plurality of training feature vectors corresponds to a respective training dataset of the plurality of training datasets;
obtaining, at the comparison NN, an input feature vector associated with an input dataset;
determining, using the comparison NN, a plurality of similarity scores based at least in part on the input feature vector and the plurality of training feature vectors,
wherein each similarity score of the plurality of similarity scores indicates a similarity between the input feature vector and a respective training feature vector of the plurality of training feature vectors; and
selecting an NN model of the plurality of NN models based at least in part on the plurality of similarity scores.

17. The method of claim 16, further comprising:
mapping the plurality of training feature vectors and the input feature vector in a feature space; and
computing a plurality of feature space distances based at least in part on a result of the mapping, wherein each feature space distance of the plurality of feature space distances indicates a distance between the input feature vector and a respective training feature vector of the plurality of training feature vectors in the feature space,
wherein determining the plurality of similarity scores comprises determining the plurality of similarity scores based at least in part on the plurality of feature space distances.

18. The method of claim 16, further comprising:
training the comparison NN according to a contrastive learning technique.

19. The method of claim 16, wherein obtaining the input feature vector comprises:
receiving a transmission that includes the input dataset; and
generating the input feature vector based at least in part on the input dataset.

20. An apparatus for wireless communication comprising:
means for obtaining, at a comparison neural network (NN), a plurality of training feature vectors associated with a plurality of NN models,
wherein each training dataset of a plurality of training datasets is associated with a respective NN model of the plurality of NN models, and
wherein each training feature vector of the plurality of training feature vectors corresponds to a respective training dataset of the plurality of training datasets;
means for obtaining, at the comparison NN, an input feature vector associated with an input dataset;
means for determining, using the comparison NN, a plurality of similarity scores based at least in part on the input feature vector and the plurality of training feature vectors,
wherein each similarity score of the plurality of similarity scores indicates a similarity between the input feature vector and a respective training feature vector of the plurality of training feature vectors; and
means for selecting an NN model of the plurality of NN models based at least in part on the plurality of similarity scores.
